(19) United States
(12) Patent Application Publication
(10) Pub. No.: US 2020/0194762 A1
(43) Pub. Date: Jun. 18, 2020

(54) MAGNESIUM HYDROXIDE USED FOR NONAQUEOUS SECONDARY BATTERY SEPARATOR, NONAQUEOUS SECONDARY BATTERY SEPARATOR, AND NONAQUEOUS SECONDARY BATTERY

(71) Applicant: KYOWA CHEMICAL INDUSTRY CO., LTD., Kagawa (JP)

(72) Inventors: Tetsuro KAMEDA, Kagawa (JP); Shigeo MIYATA, Kagawa (JP)

(21) Appl. No.: 16/617,876

(22) PCT Filed: May 31, 2018
(86) PCT No.: PCT/JP2018/021097

§ 371 Date: Nov. 27, 2019

(30) Foreign Application Priority Data
Jun. 2, 2017 (JP) 2017-109630

(51) Int. Cl. H01M 2/16; H01M 10/0525; C01F 5/22

(52) U.S. Cl. CPC H01M 2/1686; H01M 10/0525; H01M 2/1653; C01P 2004/62; C01F 5/22; C01P 2004/03; H01M 2/1646

(57) ABSTRACT

A magnesium hydroxide satisfies: (A) primary particles with an average width as measured using a SEM method of between 0.1 μm and 0.7 μm inclusive; (B) a degree of monodispersity of 50% or greater wherein degree of monodispersity (%)=(average width of primary particles as measured using the SEM method/average width of secondary particles as measured using a laser diffraction method)×100; (C) a ratio D90/D10 of the volume-based cumulative 90% particle diameter (D90) to the volume-based cumulative 10% particle diameter (D10) as measured using a laser diffraction method of 10 or less; and (D) a lattice strain in the <101> direction as measured using an X-ray diffraction method of 3×10-3 or less. A nonaqueous secondary battery separator using the magnesium hydroxide and a nonaqueous secondary battery using the separator are provided. Improved heat resistance and smoking suppressibility of a nonaqueous secondary battery are disclosed.

### TECHNICAL FIELD

The present invention relates to a magnesium hydroxide that is suitable for a nonaqueous secondary battery separator, a nonaqueous secondary battery separator in which the magnesium hydroxide is used, and a nonaqueous secondary battery in which the separator is used, and more particularly relates to a technology that improves the safety and the durability of a nonaqueous secondary battery.

### BACKGROUND ART

Nonaqueous secondary batteries typified by lithium ion secondary batteries are widely used as the main power sources for mobile electronic devices such as cellphones and notebook computers. Lithium ion secondary batteries with higher energy density, higher capacity, and higher output have been developed, and a strong demand for improvement of these properties will continue to exist. From the standpoint of meeting this demand, it is an important technical factor to ensure safety.

Conventionally, separators of lithium ion secondary batteries use a polyolefin microporous membrane made of polyethylene or polypropylene. Such separators have a shutdown function (a function in which an increase in battery temperature causes the micropores of a porous membrane to close so that electric current is blocked) and play a part in ensuring the safety of the lithium ion secondary batteries. However, in a separator using a polyolefin microporous membrane, after the shutdown function has been activated, if the battery temperature further increases, melting of the separator (a so-called meltdown) advances. As a result, a short circuit between the positive and negative electrodes occurs inside the battery, and the battery is exposed to dangers such as smoking, igniting, and exploding. For this reason, in addition to the shutdown function, separators are required to have sufficient heat resistance so as to prevent a meltdown at a temperature near the temperature at which the shutdown function is activated.

Various methods for imparting heat resistance to a separator have been proposed. For example, Patent Document 1 discloses a separator having a configuration in which a heat-resistant porous layer containing a heat-resistant resin, such as an aramid resin, and an inorganic filler made of a metal hydroxide is laminated on a polyolefin microporous membrane. In such a separator, the polyolefin microporous membrane exercises the shutdown function at a high temperature, and the heat-resistant porous layer exhibits sufficient heat resistance and prevents a meltdown from occurring even at a temperature of 200° C. or more, so that excellent heat resistance and an excellent shutdown function can be obtained. Moreover, because the metal hydroxide undergoes a dehydration reaction at a high temperature, a heat generation suppressing function is exercised, and thus safety at a high temperature can be improved even further.

Patent Document 2 discloses a nonaqueous secondary battery separator including a polyolefin porous base material and a heat-resistant porous layer that is laminated on one or both surfaces of the porous base material and that contains a heat-resistant resin and an inorganic filler, wherein the inorganic filler is made of a magnesium hydroxide powder having an average particle diameter of 0.01 to 3.0 μm and a specific surface area of 1.0 to 100 m²/g. Using the magnesium hydroxide powder having the predetermined average particle diameter and specific surface area significantly reduces the activity of water and hydrogen fluoride that are present in the battery in trace amounts, and suppresses the generation of gas due to decomposition and the like of an electrolyte. It has been determined that the battery durability can thus be greatly improved. In Examples 1 to 3, a magnesium hydroxide having an average particle diameter of 0.8 μm is used.

Patent Documents 1 and 2 disclose the nonaqueous secondary battery separators in which a magnesium hydroxide is used as the inorganic filler to improve the heat resistance and the battery durability. However, the heat resistance and the smoking suppressibility of separators that use conventional magnesium hydroxides are still insufficient, and there is a demand for improvement of magnesium hydroxide.

### CITATION LIST

### Patent Documents

Patent Document 1: WO 2008/156033

Patent Document 2: JP 2011-108444A

### SUMMARY OF INVENTION

### Technical Problem

An object that is addressed by the present application is to improve the heat resistance and the smoking suppressibility of a nonaqueous secondary battery. Conventionally, a magnesium hydroxide in which secondary particles have an average width of about 0.8 μm is used for the purpose of improving the heat resistance of batteries; however, with demand for a reduction in the thickness of separators, a magnesium hydroxide having an even smaller particle diameter has been in demand. However, a conventional magnesium hydroxide with a small particle diameter exhibits strong aggregability when used as a suspension for coating, and therefore cannot be uniformly applied to the polyolefin microporous membrane, causing the problem of a decrease in heat resistance. Moreover, for further enhancement of safety, there is a demand for improvement of smoking suppressibility at high temperatures.

### Solution to Problem

As a result of in-depth research, the inventors of the present invention found that, in a nonaqueous secondary battery separator including a polyolefin porous base material and a heat-resistant porous layer that is laminated on one or both surfaces of the porous base material and that contains a heat-resistant resin and a magnesium hydroxide, the above-described problems can be addressed by adding a magnesium hydroxide that has a specific structure to the heat-resistant porous layer.

The present invention provides a magnesium hydroxide that addresses the above-described problems, the magnesium hydroxide being for use in a nonaqueous secondary battery separator and satisfying (A) to (D) below.

(A) the average width of primary particles as measured using a SEM method is between 0.1 μm and 0.7 μm inclusive;

(B) the degree of monodispersity expressed by an equation below is 50% or greater:

Degree of monodispersity (%)=(average width of primary particles as measured using the SEM method/average width of secondary particles as measured using a laser diffraction method)×100;

(C) the ratio D90/D10 of the volume-based cumulative 90% particle diameter (D90) to the volume-based cumulative 10% particle diameter (D10) as measured using a laser diffraction method is 10 or less; and

(D) the lattice strain in the <101> direction as measured using an X-ray diffraction method is 3×10⁻³ or less.

The present invention also provides a nonaqueous secondary battery separator that addresses the above-described problems, the nonaqueous secondary battery separator including a polyolefin porous base material and a heat-resistant porous layer laminated on one or both surfaces of the porous base material, wherein the heat-resistant porous layer contains a heat-resistant resin and the above-described magnesium hydroxide.

The present invention also provides a nonaqueous secondary battery configured to obtain an electromotive force through doping and de-doping of lithium, wherein the above-described nonaqueous secondary battery separator is used.

### Advantageous Effects of Invention

The nonaqueous secondary battery separator in which the magnesium hydroxide of the present invention is used contributes to an improvement in the safety and the durability of a nonaqueous secondary battery.

### BRIEF DESCRIPTION OF DRAWINGS

FIG. 1 is a schematic diagram for explaining the width and the thickness of a primary particle of a magnesium hydroxide of the present invention.

FIG. 2 is a schematic diagram for explaining the width of a secondary particle of the magnesium hydroxide of the present invention.

FIG. 3 is a SEM micrograph at a magnification of 20,000 in which a magnesium hydroxide A of Example 1 was observed.

FIG. 4 is a SEM micrograph at a magnification of 20,000 in which a magnesium hydroxide B of Example 2 was observed.

FIG. 5 is a SEM micrograph at a magnification of 20,000 in which a magnesium hydroxide C of Example 3 was observed.

FIG. 6 is a SEM micrograph at a magnification of 20,000 in which a magnesium hydroxide D of Comparative Example 1 was observed.

FIG. 7 is a SEM micrograph at a magnification of 20,000 in which a magnesium hydroxide F of Comparative Example 3 was observed.

### DESCRIPTION OF EMBODIMENTS

Hereinafter, the present invention will be described in detail.

### <Nonaqueous Secondary Battery Separator>

### (Configuration)

A nonaqueous secondary battery separator of the present invention includes a polyolefin porous base material and a heat-resistant porous layer laminated on one or both surfaces of the porous base material. The heat-resistant porous layer contains a heat-resistant resin and a magnesium hydroxide of the present invention.

### (Film Thickness)

The nonaqueous secondary battery separator of the present invention has a film thickness of 7 to 25 μm, and preferably 10 to 20 μm. A film thickness of less than 7 μm causes a reduction in the mechanical strength and is therefore not preferable. On the other hand, a film thickness of more than 25 μm is not preferable in terms of ion permeability, and is also not preferable in that the volume occupied by the separator within the battery increases, which leads to a reduction in the energy density.

### (Porosity)

The nonaqueous secondary battery separator of the present invention has a porosity of 20 to 70%, and preferably 30 to 60%. A porosity of less than 20% makes it difficult to retain a sufficient amount of electrolytic solution for the operation of the battery, causes significant degradation of the charge and discharge characteristics of the battery, and is therefore not preferable. A porosity of more than 70% results in insufficient shutdown characteristics and a reduction in the mechanical strength and the heat resistance, and is therefore not preferable.

### (Puncture Strength)

The nonaqueous secondary battery separator of the present invention has a puncture strength of 200 g or greater, preferably 250 g or greater, and more preferably 300 g or greater. A puncture strength of less than 200 g means insufficient mechanical strength for preventing a short circuit between the positive and negative electrodes in the battery, keeps the production yield from increasing, and is therefore not preferable.

### (Gurley Value)

The nonaqueous secondary battery separator of the present invention has a Gurley value (JIS P8117) of 150 to 600 sec/100 cc, and preferably 150 to 400 sec/100 cc. A Gurley value of less than 150 sec/100 cc causes degradation of the shutdown characteristics and the mechanical strength even though excellent ion permeability is achieved, and is therefore not preferable. Furthermore, a Gurley value of less than 150 sec/100 cc may cause a problem in that, when forming the porous layer, clogging occurs at the interface between the polyolefin porous base material and the heat-resistant porous layer, and is therefore not preferable. On the other hand, a Gurley value of more than 600 sec/100 cc results in insufficient ion permeability and may cause degradation of the load characteristics of the battery, and is therefore not preferable.

A value obtained by subtracting the Gurley value of the polyolefin porous base material used in the nonaqueous secondary battery separator of the present invention from the Gurley value of the nonaqueous secondary battery separator is 250 sec/100 cc or less, and preferably 200 sec/100 cc or less. The smaller this value, the better, because more favorable shutdown characteristics and superior ion permeability can be achieved.

### <Polyolefin Porous Base Material>

### (Configuration)

The polyolefin porous base material of the present invention contains a polyolefin, and has a porous structure in which a large number of holes or interstices are internally present, and these holes or the like are connected to each other. Regarding the configuration of the base material, for example, a microporous membrane, a nonwoven fabric, a paper-like sheet, and other sheets having a three-dimensional network structure can be used, and a microporous membrane is preferable in terms of ease of handling and strength. A microporous membrane means a membrane that has a structure in which a large number of minute pores are internally present and connected to each other and that allows gas or liquid to pass through from one side to the other side.

### (Polyolefin Resin)

Examples of a polyolefin resin constituting the porous base material of the present invention include polyethylenes, polypropylenes, polymethylpentenes, and the like. Among these, a polyolefin resin containing a polyethylene in an amount of 90 wt % or greater is preferable for the reason that favorable shutdown characteristics can be obtained. Among the polyethylenes, low density polyethylenes, high density polyethylenes, ultra-high molecular weight polyethylenes, and the like can be suitably used; with high density polyethylenes and ultra-high molecular weight polyethylenes being particularly preferable, and a mixture of a high density polyethylene and an ultra-high molecular weight polyethylene is more preferable in terms of strength and formability. Regarding the molecular weight, polyethylenes having a weight average molecular weight of 100,000 to 10,000,000 are preferable, and a polyethylene composition in which an ultra-high molecular weight polyethylene having a weight average molecular weight of 1,000,000 or greater is contained in an amount of at least 1 wt % is particularly preferable. Moreover, in addition to polyethylenes, the porous base material of the present invention may be composed of other polyolefins, such as polypropylenes and polymethylpentenes, mixed with the polyethylenes, or may be configured as a laminate of two or more layers including a polyethylene microporous membrane and a polypropylene microporous membrane.

### (Film Thickness)

The film thickness of the polyolefin porous base material of the present invention is preferably 5 to 20 μm. If the film thickness is less than 5 μm, sufficient mechanical strength cannot be obtained, making handling difficult and causing a significant reduction in the yield of the battery, and such a film thickness is therefore not preferable. On the other hand, a film thickness of greater than 20 μm makes it difficult for ions to migrate and increases the volume occupied by the separator within the battery, causing a reduction in the energy density of the battery, and is therefore not preferable.

### (Porosity)

The polyolefin porous base material of the present invention has a porosity of 10 to 60%, and more preferably 20 to 50%. A porosity of the polyolefin porous base material of less than 10% makes it difficult to retain a sufficient amount of electrolytic solution for operations of the battery, resulting in significant degradation of the charge and discharge characteristics of the battery, and is therefore not preferable. On the other hand, a porosity of greater than 60% results in insufficient shutdown characteristics and a reduction in mechanical strength, and is therefore not preferable.

### (Puncture Strength)

The polyolefin porous base material of the present invention has a puncture strength of 200 g or greater, preferably 250 g or greater, and more preferably 300 g or greater. A puncture strength of less than 200 g means insufficient mechanical strength for preventing a short circuit between the positive and negative electrodes in the battery and keeps the production yield from increasing, and is therefore not preferable.

### (Gurley Value)

The polyolefin porous base material of the present invention has a Gurley value (JIS P8117) of 100 to 500 sec/100 cc, and preferably 100 to 300 sec/100 cc. A Gurley value of less than 100 sec/100 cc causes degradation of the shutdown characteristics and the mechanical strength even though excellent ion permeability is achieved. On the other hand, a Gurley value of greater than 500 sec/100 cc results in insufficient ion permeability and also causes degradation of the load characteristics of the battery, and is therefore not preferable.

### (Average Pore Diameter)

The polyolefin porous base material of the present invention has an average pore diameter of 10 to 100 nm. If the pores are smaller than 10 nm, a problem may arise in that impregnation with the electrolytic solution is difficult. On the other hand, if the pores are larger than 100 nm, clogging may occur at the interface when forming the porous layer, and the shutdown characteristics may significantly degrade when the porous layer is formed, and therefore, such pore diameters are not preferable.

### <Heat-Resistant Porous Layer>

### (Configuration)

The heat-resistant porous layer of the present invention contains a heat-resistant resin and a magnesium hydroxide, and has a porous structure in which a large number of holes or interstices are internally present, and these holes or the like are connected to each other. In terms of ease of handling and the like, it is preferable that this heat-resistant porous layer has a configuration in which the magnesium hydroxide in a state in which it is dispersed in and bound to the heat-resistant resin is directly fixed onto the polyolefin porous base material. Note that a configuration may also be adopted in which a porous layer composed only of the heat-resistant resin is formed on the polyolefin porous base material in advance, and the magnesium hydroxide is attached to the inside of the pores of, or a surface of, the heat-resistant resin layer afterward using a method of, for example, applying a solution containing the magnesium hydroxide to the porous layer or immersing the porous layer in the solution. Moreover, a configuration may also be adopted in which the heat-resistant porous layer is configured as an independent porous sheet such as a microporous membrane, a nonwoven fabric, a paper-like sheet, or the like, and this porous sheet is bonded to the polyolefin porous base material.

In the present invention, the composition of the heat-resistant porous layer in terms of weight ratio is heat-resistant resin:magnesium hydroxide=10:90 to 80:20, and more preferably, this weight ratio is within a range of 10:90 to 50:50. A magnesium hydroxide content of less than 20 wt % makes it difficult to sufficiently impart the features of the magnesium hydroxide. On the other hand, a magnesium hydroxide content of greater than 90 wt % makes it difficult to form the heat-resistant porous layer, and is therefore not preferable. However, a magnesium hydroxide content of 50 wt % or greater improves the heat-resistant characteristics including the effect of suppressing thermal shrinkage, and is therefore preferable.

In the present invention, it is sufficient that the heat-resistant porous layer is formed on at least one surface of the polyolefin porous base material. However, it is more preferable that porous layers are formed on both the front and back surfaces of the polyolefin porous base material. The following effects can be obtained by forming porous layers on both the front and back surfaces of the polyolefin porous base material: curling is prevented, and the ease of handling is therefore improved; the heat resistance, including the dimensional stability at high temperatures, is also improved; and the cycle characteristics of the battery are also significantly improved.

### (Porosity)

The porosity of the heat-resistant porous layer is 30 to 80%. Furthermore, it is preferred that the porosity of the heat-resistant porous layer is higher than the porosity of the polyolefin porous base material. This configuration is advantageous in terms of the characteristics, that is, for example, favorable shutdown characteristics and excellent ion permeability are obtained.

### (Thickness)

Regarding the thickness of the heat-resistant porous layer, in the case where heat-resistant porous layers are formed on both surfaces of the polyolefin porous base material, it is preferable that the sum of the thicknesses of the heat-resistant porous layers is 2 to 12 μm, and in the case where a heat-resistant porous layer is formed on only one surface, it is preferable that the thickness of the heat-resistant porous layer is 4 to 24 μm.

### <Heat-Resistant Resin>

The heat-resistant resin of the present invention is a resin that has sufficient heat resistance so as not to melt or thermally decompose even at a temperature exceeding the melting point of the polyolefin porous base material. For example, a resin having a melting point of 200° C. or more, or a resin substantially having no melting point, can be suitably used if it is a resin having a thermal decomposition temperature of 200° C. or more. Examples of this heat-resistant resin include aromatic polyamides, polyimides, polyamide-imides, polysulfones, polyketones, polyether ketones, polyether sulfones, polyether imides, cellulose, and polyvinylidene fluoride, as well as a combination of two or more thereof. Among these, aromatic polyamides are preferable in terms of ease of forming the porous layer, the property of binding to the magnesium hydroxide, and the resulting durability, including the strength and the oxidation resistance, of the porous layer. Moreover, among the aromatic polyamides, meta-type aromatic polyamides are preferable for the reason that the meta-types are easier to form than para-types, and meta-phenyleneisophthalamide is particularly preferable.

### <Magnesium Hydroxide>

### (Chemical Formula)

The magnesium hydroxide of the present invention is represented by the following formula (1):

Mg(OH)₂ (1)

### (Definition of Primary Particle)

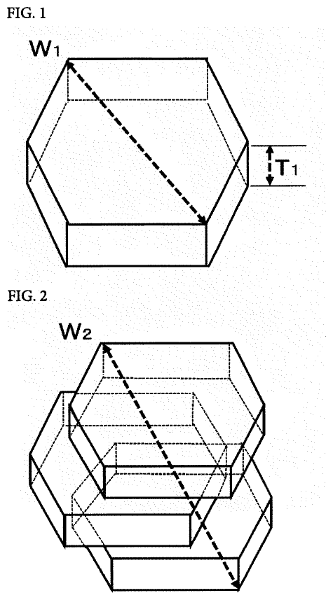

A primary particle is a particle that has a clear boundary and cannot be geometrically divided any further. FIG. 1 is a schematic diagram for explaining the width (W₁) and the thickness (T₁) of a primary particle used in the present invention. The width W₁ of the primary particle and the thickness T₁ of the primary particle are defined as shown in FIG. 1. That is to say, assuming that the primary particle has a hexagonal plate-shaped surface, the major diameter of the particle is the “width W₁ of the primary particle”, and the thickness of the plate-shaped surface is the “thickness T₁ of the primary particle”.

### (Definition of Secondary Particle)

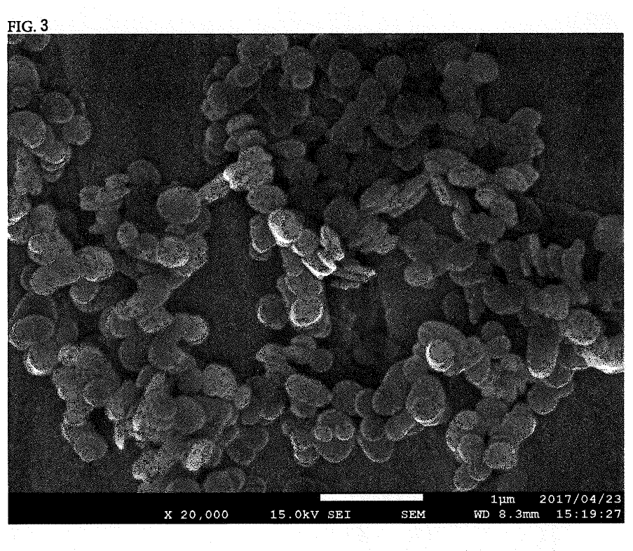

A secondary particle is a particle that is an aggregate formed of a collection of a plurality of primary particles. FIG. 2 is a schematic diagram for explaining the width (W₂) of a secondary particle used in the present invention. The width W₂ of the secondary particle is defined as shown in FIG. 2. That is to say, assuming that the secondary particle is enclosed in a sphere, the diameter of the sphere is the “width W₂ of the secondary particle”.

### (Average Width of Primary Particles)

The average width of primary particles of the magnesium hydroxide of the present invention as measured using a SEM method is 0.1 to 0.7 μm, preferably 0.15 to 0.65 μm, and more preferably 0.2 to 0.6 μm. An average width of primary particles of less than 0.1 μm causes blockage of pores of the heat-resistant porous layer, resulting in a porosity of the heat-resistant porous layer of less than 30%, and is therefore not preferable. On the other hand, an average width of primary particles of greater than 0.7 μm causes degradation of the heat resistance and the smoking suppressibility of the separator, and is therefore not preferable. The average width of primary particles is obtained from an arithmetic mean of measured values of the width of any 100 crystals in a SEM micrograph, using the SEM method. In principle, the width of primary particles cannot be measured using a laser diffraction method. Therefore, the width of primary particles is visually observed using the SEM method.

### (Average Thickness of Primary Particles)

The average thickness of primary particles of the magnesium hydroxide of the present invention as measured using a SEM method is 20 to 100 nm, preferably 20 to 90 nm, and more preferably 20 to 80 nm. An average thickness of primary particles of greater than 100 nm results in insufficient smoking suppressibility of the separator, and is therefore not preferable. An average thickness of primary particles of less than 20 nm increases aggregation of primary particles, and is therefore not preferable. The average thickness of primary particles is obtained from an arithmetic mean of measured values of the thickness of any 100 crystals in a SEM micrograph, using the SEM method. In principle, the thickness of primary particles cannot be measured using a laser diffraction method. Therefore, the thickness of primary particles is visually observed using the SEM method.

### (Degree of Monodispersity)

The degree of monodispersity of the magnesium hydroxide of the present invention, expressed by the equation below, is 50% or greater, preferably 60% or greater, more preferably 70% or greater, and even more preferably 80% or greater. A degree of monodispersity of less than 50% causes insufficient dispersion of the magnesium hydroxide in the heat-resistant porous layer, resulting in degradation of the heat resistance of the separator, and is therefore not preferable. The average width of secondary particles is measured using a laser diffraction method, because it is difficult to accurately measure the width of secondary particles using a SEM method.

Degree of monodispersity (%)=(average width of primary particles as measured using SEM method/average width of secondary particles as measured using laser diffraction method)×100

### (D90)

The volume-based cumulative 90% particle diameter (D90) of the magnesium hydroxide of the present invention as measured using a laser diffraction method is 1 μm or less, and preferably 0.9 μm or less. A D90 of greater than 1 μm causes degradation of the durability of the separator, and is therefore not preferable.

### (D90/D10)

The ratio D90/D10 of the volume-based cumulative 90% particle diameter (D90) to the volume-based cumulative 10% particle diameter (D10) of the magnesium hydroxide of the present invention as measured using the laser diffraction method is 10 or less, preferably 8 or less, more preferably 6 or less, and most preferably 4 or less. The lower the value of D90/D10, the better, because a sharper particle size distribution and a more uniform particle diameter are obtained. A D90/D10 value of greater than 10 causes degradation of the heat resistance of the separator due to coarse particles and minute particles, and is therefore not preferable.

### (Lattice Strain in the <101> Direction)

The lattice strain in the <101> direction of the magnesium hydroxide of the present invention as measured using an X-ray diffraction method is 3×10⁻³ or less, preferably 2.5×10⁻³ or less, more preferably 2×10⁻³ or less, and even more preferably 1.5×10⁻³ or less. The smaller the lattice strain, the fewer lattice defects the magnesium hydroxide crystals contain, and the less likely the primary particles are to aggregate. A lattice strain of greater than 3×10⁻³ results in many lattice defects and hence insufficient dispersion of the magnesium hydroxide in the heat-resistant porous layer, causing degradation of the heat resistance of the separator, and is therefore not preferable.

### (Aspect Ratio of Primary Particles)

The aspect ratio (average width of primary particles as measured using a SEM method/average thickness of primary particles as measured using the SEM method) of primary particles of the magnesium hydroxide of the present invention is preferably 10 or greater, and more preferably 15 or greater. An aspect ratio of 10 or greater makes it possible to reduce the thickness of the heat-resistant porous layer and improve the smoking suppressibility of the separator.

### (Zeta Potential)

The absolute value of the zeta potential of the magnesium hydroxide of the present invention is 15 mV or greater, preferably 20 mV or greater, more preferably 25 mV or greater, and even more preferably 30 mV or greater. An absolute value of the zeta potential of less than 15 mV weakens the electrostatic repulsion between primary particles of the magnesium hydroxide, resulting in insufficient dispersion thereof in the heat-resistant porous layer and causing degradation of the heat resistance of the separator, and is therefore not preferable.

### (Amount of Impurities)

The total amount of a chromium compound, a manganese compound, an iron compound, a cobalt compound, a nickel compound, a copper compound, and a zinc compound that are contained in the magnesium hydroxide of the present invention is 200 ppm or less, preferably 150 ppm or less, and more preferably 100 ppm or less, in terms of the metals (Cr, Mn, Fe, Co, Ni, Cu, and Zn). A total amount of the above-described impurities contained of greater than 200 ppm results in degradation of the durability of the nonaqueous secondary battery and causes a short circuit, and is therefore not preferable.

### (Surface Treatment)

In the magnesium hydroxide of the present invention, in order to improve the dispersibility in the heat-resistant porous layer, it is preferable that particles are surface-treated. Examples of a surface treatment agent include, but are not limited to, an anionic surfactant, a cationic surfactant, a phosphate ester treatment agent, a silane coupling agent, a titanate coupling agent, an aluminum coupling agent, a silicone-based treatment agent, silicic acid, water glass, and the like. When the dispersibility of the magnesium hydroxide in the heat-resistant porous layer is taken into account, at least one surface treatment agent selected from the group consisting of octylic acid and octanoic acid is particularly preferable. The total amount of surface treatment agent is 0.01 to 20 wt %, and preferably 0.1 to 15 wt %, with respect to the magnesium hydroxide.

### <Nonaqueous Secondary Battery>

The nonaqueous secondary battery of the present invention is a nonaqueous secondary battery configured to obtain an electromotive force through doping and de-doping of lithium, in which the above-described nonaqueous secondary battery separator of the present invention is used. As such, the nonaqueous secondary battery of the present invention is highly safe and has high durability at high temperatures and also has excellent cycle characteristics and the like.

### (Configuration)

The type and the configuration of the nonaqueous secondary battery of the present invention are not limited, and the present invention is applicable to any nonaqueous secondary battery that has a structure in which a battery element in which a positive electrode, a separator, and a negative electrode are sequentially laminated is impregnated with an electrolytic solution, and the impregnated battery element is enclosed in an exterior material.

### (Negative Electrode)

The negative electrode has a structure in which a negative electrode mixture, the mixture containing a negative electrode active material, a conductive aid, and a binder, is formed on a current collector (copper foil, stainless steel foil, nickel foil, or the like). A material that is capable of electrochemically doping lithium, such as a carbon material, silicone, aluminum, or tin, for example, is used as the negative electrode active material.

### (Positive Electrode)

The positive electrode has a structure in which a positive electrode mixture, the mixture containing a positive electrode active material, a conductive aid, and a binder, is formed on a current collector. A lithium-containing transition metal oxide, such as LiCoO₂, LiNiO₂, LiMn_{0.5}Ni_{0.5}O₂, LiCo_{1/3}Ni_{1/3}Mn_{1/3}O₂, LiMn₂O₄, or LiFePO₄, for example, is used as the positive electrode active material.

### (Electrolytic Solution)

The electrolytic solution has a configuration in which a lithium salt, such as LiPF₆, LiBF₄, or LiClO₄, for example, is dissolved in a nonaqueous solvent. Examples of the nonaqueous solvent include propylene carbonate, ethylene carbonate, dimethyl carbonate, diethyl carbonate, ethyl methyl carbonate, γ-butyrolactone, vinylene carbonate, and the like.

### (Exterior Material)

A metal can, an aluminum laminate pack, or the like can be used as the exterior material. The battery may be rectangular, cylindrical, or coin-shaped, for example, and the separator of the present invention can be suitably applied to all of the battery shapes.

### <Method for Producing Magnesium Hydroxide>

A method for producing the magnesium hydroxide of the present invention includes the following steps (1) to (4): (1) a step of preparing an aqueous solution of a water-soluble magnesium salt and an aqueous solution of a water-soluble alkali salt; (2) a step of causing the obtained aqueous solution of the water-soluble magnesium salt and the aqueous solution of the water-soluble alkali salt to continuously react with each other at a reaction temperature of 0 to 60° C. and a reaction pH of 9.2 to 11.0 to obtain a suspension containing a magnesium hydroxide; (3) a step of dehydrating the obtained suspension containing the magnesium hydroxide, and then performing washing with water and suspending the product in water and/or an organic solvent; and (4) a step of stirring and retaining the obtained suspension containing the washed magnesium hydroxide at 50 to 150° C. for 1 to 60 hours.

### (Step 1)

In the above-described step (1), examples of the water-soluble magnesium salt include, but are not limited to, magnesium chloride, magnesium nitrate, magnesium acetate, magnesium sulfate, and the like. In order to prevent aggregation of primary particles, it is preferable to use magnesium chloride, magnesium nitrate, and magnesium acetate that contain a monovalent anion. Examples of the water-soluble alkali salt include, but are not limited to, sodium hydroxide, potassium hydroxide, ammonium hydroxide, and the like. It is possible to suppress the thickness of the primary particles of the magnesium hydroxide and increase the aspect ratio of the primary particles by further using a monovalent organic acid and/or a monovalent organic acid salt as the raw material. Examples of the monovalent organic acid and the monovalent organic acid salt include, but are not limited to, acetic acid, sodium acetate, propionic acid, sodium propionate, butyric acid, sodium butyrate, and the like.

The concentration of the aqueous solution of the magnesium salt in terms of magnesium ions is 0.1 to 5 mol/L, and preferably 0.5 to 4 mol/L. The concentration of the aqueous solution of the alkali salt in terms of hydroxide ions is 0.1 to 20 mol/L, and preferably 0.5 to 15 mol/L. The concentration of an aqueous solution of the monovalent organic acid and/or the monovalent organic acid salt is 0.01 to 1 mol/L. The total amount of a chromium compound, a manganese compound, an iron compound, a cobalt compound, a nickel compound, a copper compound, and a zinc compound that are contained in each raw material is 200 ppm or less, preferably 150 ppm or less, and more preferably 100 ppm or less, in terms of the metals (Cr, Mn, Fe, Co, Ni, Cu, and Zn).

### (Step 2)

In the above-described step (2), with consideration given to productivity and reaction uniformity, a continuous reaction method is used as the reaction method. During the reaction, the pH is adjusted to 9.2 to 11.0, and preferably 9.4 to 10.8. A reaction pH of less than 9.2 leads to low productivity, and is therefore not preferable for economic reasons. A reaction pH of more than 11.0 makes it more likely for impurities derived from the raw materials to precipitate and is also economically unfavorable, and is therefore not preferable. During the reaction, the concentration in terms of the magnesium hydroxide is 0.1 to 300 g/L, preferably 1 to 250 g/L, and more preferably 5 to 200 g/L. During the reaction, a concentration of less than 0.1 g/L leads to low productivity and is therefore not preferable, and a concentration of more than 300 g/L causes aggregation of primary particles and is therefore not preferable. The reaction temperature is 0 to 60° C., preferably 10 to 50° C., and more preferably 20 to 40° C. A reaction temperature of more than 60° C. increases the lattice strain in the <101> direction, causing aggregation of primary particles, and is therefore not preferable. A reaction temperature of less than 0° C. causes the reaction liquid to freeze, and is therefore not preferable.

### (Step 3)

In the above-described step (3), the suspension containing the magnesium hydroxide prepared in the step (2) is dehydrated, then washed with an amount of deionized water that is 20 times the weight of the magnesium hydroxide, and resuspended in water and/or an organic solvent. By performing this step, impurities such as sodium can be removed, and thus, aggregation of primary particles of the magnesium hydroxide can be prevented.

### (Step 4)

In the above-described step (4), the suspension containing the magnesium hydroxide prepared in the step (3) is stirred and retained at 50 to 150° C. for 1 to 60 hours. By performing this step, aggregation of primary particles can be alleviated, and a suspension in which primary particles are sufficiently dispersed can be obtained. An aging time of less than 1 hour is an insufficient length of time to alleviate the aggregation of primary particles. Even when aging is performed longer than 60 hours, the aggregation state remains unchanged, and is thus pointless. The aging time is preferably 2 to 30 hours, and more preferably 4 to 24 hours. An aging temperature of more than 150° C. causes primary particles to grow to be larger than 0.7 μm, and is therefore not preferable. An aging temperature of less than 50° C. causes primary particles to be smaller than 0.1 μm, and is therefore not preferable. The aging temperature is preferably 60 to 140° C., and more preferably 70 to 130° C. During the aging, the concentration in terms of the magnesium hydroxide is 0.1 to 300 g/L, preferably 0.5 to 250 g/L, and more preferably 1 to 200 g/L. During the aging, a concentration of less than 0.1 g/L leads to low productivity and is therefore not preferable, and a concentration of more than 300 g/L causes aggregation of primary particles and is therefore not preferable.

Surface-treatment of the magnesium hydroxide particles obtained in the step (4) can improve the dispersibility of the particles in a resin when the particles are added to, kneaded, or dispersed in the resin. A wet method or a dry method can be used for the surface treatment. When uniformity of the treatment is taken into account, a wet method is suitably used. The temperature of the suspension after wet grinding is adjusted, and a dissolved surface treatment agent is added thereto under stirring. During the surface treatment, the temperature is appropriately adjusted to a temperature at which the surface treatment agent dissolves.

For example, at least one surface treatment agent selected from the group consisting of an anionic surfactant, a cationic surfactant, a phosphate ester treatment agent, a silane coupling agent, a titanate coupling agent, an aluminum coupling agent, a silicone-based treatment agent, silicic acid, water glass, and the like can be used as the surface treatment agent. In order to improve the dispersibility of the magnesium hydroxide in the heat-resistant porous layer, at least one surface treatment agent selected from the group consisting of octylic acid and octanoic acid is particularly preferable. The total amount of surface treatment agent is preferably 0.01 to 20 wt %, and more preferably 0.1 to 15 wt %, with respect to the weight of the magnesium hydroxide.

After the surface treatment, the suspension is dehydrated, followed by washing with an amount of deionized water that is 20 times the solid content in weight. Then, the magnesium hydroxide of the present invention is obtained. Hot-air drying, vacuum drying, or the like can be used as the drying method, but the drying method is not limited to a specific method.

### <Method for Producing Nonaqueous Secondary Battery Separator>

A method for producing the nonaqueous secondary battery separator of the present invention includes the following steps (1) to (4): (1) a step of preparing a coating suspension containing the heat-resistant resin, the magnesium hydroxide, and a water-soluble organic solvent; (2) a step of coating one or both surfaces of the polyolefin porous base material with the obtained coating suspension; (3) a step of coagulating the heat-resistant resin in the coating of the suspension; and (4) a step of washing a sheet after the coagulation step, with water and drying the sheet.

### (Step 1)

In the above-described step (1), any solvent that is a good solvent for the heat-resistant resin can be used as the water-soluble organic solvent without limitation. Specifically, for example, polar solvents such as N-methylpyrrolidone, dimethylacetamide, dimethylformamide, and dimethyl sulfoxide can be used. In addition, a solvent that is a poor solvent for the heat-resistant resin can also be used mixed in the suspension as a portion thereof. The use of such a poor solvent induces a micro-phase separation structure, and thus, when forming the heat-resistant porous layer, it is easy to make the layer porous. Solvents such as alcohols are preferable as the poor solvent. In particular, polyhydric alcohols like glycols are preferable.

### (Step 2)

In the above-described step (2), the amount of suspension with which the polyolefin porous base material is coated is preferably about 2 to 3 g/m². Examples of the coating method include a knife coater method, a gravure coater method, a screen printing method, a Meyer bar method, a die coater method, a reverse roll coater method, an inkjet method, a spray method, a roll coater method, and the like. Among these, from the standpoint of applying a uniform coating, a reverse roll coater method is preferable.

### (Step 3)

In the above-described step (3), examples of the method for coagulating the heat-resistant resin in the suspension include spraying a coagulation liquid onto the coated polyolefin porous base material with the use of a sprayer, immersing the base material in a bath (coagulation bath) containing a coagulation liquid, and so on. Any coagulation liquid capable of coagulating the heat-resistant resin can be used without limitation, but water or a mixed solution in which an appropriate amount of water is contained in the two solvents used in the suspension is preferable. Here, the amount of water that is mixed is preferably 40 to 80 wt % with respect to the coagulation liquid.

### (Step 4)

In the above-described step (4), the drying method is not limited to a specific method, but an appropriate drying temperature is 50 to 80° C. When using a high drying temperature, it is preferable to use a method in which the sheet is brought into contact with a roll in order to prevent a change in the size thereof due to thermal shrinkage.

Note that, in the present invention, although the method for producing the polyolefin porous base material is also not limited to a specific method, a polyolefin microporous membrane can be produced in the following manner, for example. That is to say, a piece of base tape is prepared by extruding a gel-like mixture of a polyolefin and liquid paraffin from a die and then cooling the extruded product. This piece of base tape is stretched, and the stretched base tape is thermally immobilized. After that, the liquid paraffin is extracted through immersion in an extracting solvent such as methylene chloride, and then the extracting solvent is dried. Thus, a polyolefin microporous membrane can be obtained.

Hereinafter, the present invention will be described in detail using examples. However, the present invention is not limited only to these examples. In the examples below, various properties were measured using the following methods.

### (a) Average Width and Average Thickness of Primary Particles

A sample was added to ethanol, and ultrasonic treatment was performed for 5 minutes. After that, the width and the thickness of primary particles in any 100 crystals were measured using a scanning electron microscope (SEM) (JSM-7600F manufactured by JEOL Ltd.), and the arithmetic means of the measured values were used as the average width and the average thickness of primary particles.

### (b) Average Width of Secondary Particles and D90/D10

A sample was added to ethanol, and ultrasonic treatment was performed for 5 minutes. After that, the volume-based cumulative 10% particle diameter (D10), the volume-based cumulative 50% particle diameter (D50), and the volume-based cumulative 90% particle diameter (D90) were measured using a laser diffraction and scattering type particle size distribution measuring apparatus (MT3300 manufactured by MicrotracBEL Corp.). D50 was used as the average width of secondary particles, and D90/D10 was obtained from the values of D10 and D90.

### (c) Degree of Monodispersity

The degree of monodispersity was calculated from the values of (a) and (b) based on the following equation.

Degree of monodispersity (%)=(average width of primary particles/average width of secondary particles)×100

### (d) Aspect Ratio of Primary Particles

The aspect ratio of primary particles was calculated from the values of (a) based on the following equation.

Aspect ratio of primary particles=average width of primary particles/average thickness of primary particles

### (e) Crystal Strain in the <101> Direction

Based on the following relational expression, (sin θ/λ) is plotted on the horizontal axis and (β cos θ/λ) on the vertical axis, and then, the crystal grain diameter (g) is obtained from the reciprocal of the intercept, and the crystal strain (η) is obtained by multiplying the gradient by (1/2).

(β cos θ/λ)=(1/g)+2η×(sin θ/λ)

where λ indicates the wavelength of an X ray that is used, and is 1.542 Å when a Cu-Kα ray is used; θ indicates the Bragg angle; and β indicates the true half-width (unit: radian).

The above-described β is obtained using the following method.

An X-ray diffractometer (Empyrean manufactured by PANalytical) is used, and diffraction profiles of the (101) plane and the (202) plane are measured using, as an X-ray source, a Cu-Kα ray that is generated under conditions of 45 KV and 40 mA. With respect to the measurement conditions, the measurement is performed under conditions at a goniometer speed of 10°/min with slit widths of 1°-0.3 mm-1° for the (101) plane and 2°-0.3 mm-2° for the (202) plane in the order of the divergence slit, the receiving slit, and the scattering slit. In the obtained profiles, the width (B₀) at (1/2) of the height from the background to a diffraction peak is measured. From the relationship of the split width (δ) between K_{α1} and K_{α2} against 2θ, δ against 2θ of each of the (101) plane and the (202) plane is read. Next, based on the values of B₀ and δ described above, B is obtained from the relationship between (δ/B₀) and (B/B₀). Subsequently, with respect to high-purity silicon (purity: 99.999%), diffraction profiles are measured with slit widths of (1/2)°-0.3 mm-(1/2°), and the half-width (b) is obtained. This is plotted against 2θ, and a graph showing the relationship between b and 2θ is created. (b/β) is obtained from b corresponding to 2θ of each of the (101) plane and the (202) plane. β is obtained from the relationship between (b/B) and (6/B).

### (f) Zeta Potential

A sample was added to ethanol, and ultrasonic treatment was performed for 5 minutes. Then, the zeta potential was measured using a particle size measuring apparatus based on a dynamic light scattering method (ELSZ-2 manufactured by Otsuka Electronics Co., Ltd.).

### (g) Quantitative Determination of Impurities

A sample was heated and dissolved in nitric acid. Then, the amounts of respective elements Cr, Mn, Fe, Co, Ni, Cu, and Zn contained were measured using an ICP optical emission spectrometer (PS3520VDD2 manufactured by Hitachi High-Tech Science Corporation).

### (h) Quantitative Determination of Surface Treatment Amount

The amount of octylic acid coating with respect to the weight of a sample was calculated using an ether extraction method.

### (i) Film Thickness of Heat-Resistant Porous Layer and Separator

For each sample, measurement was performed at 20 points using a contact-type film thickness gauge (manufactured by Mitutoyo Corporation), and an arithmetic mean of the measured values was calculated as the film thickness. Here, a cylindrical contact probe having a bottom diameter of 0.5 cm was used.

### (j) Porosity

The weight (Wi: g/m₂) of each constituent material was divided by the true density (di: g/cm³), and the sum (Σ(Wi/di)) of the resulting values was obtained. The obtained sum was divided by the film thickness (μm), the quotient was subtracted from 1, and the value of the difference was multiplied by 100. Thus, the porosity (%) was calculated.

### (k) Gurley Value

In conformity with JIS P8117, the Gurley value (sec/100 cc) was measured using a Gurley type densometer (G-B2C manufactured by Toyo Seiki Seisaku-sho, Ltd.).

### (1) Puncture Strength

A puncture test was performed using a handy compression tester (KES-G5 manufactured by Kato Tech Co., Ltd.) under conditions of a radius of curvature at the needle tip of 0.5 mm and a puncture speed of 2 mm/sec, and the maximum puncture load (g) measured was used as the puncture strength. Here, a sample was clamped and fixed in a metal frame (sample holder) with a hole with a diameter of 11.3 mm.

### (m) Shutdown Characteristics (SD Characteristics)

A sample with a diameter of 19 mm was punched out from the separator, immersed in a 3 wt % methanol solution of a nonionic surfactant (EMULGEN 210P manufactured by Kao Corporation), and air-dried. The separator sample was impregnated with an electrolytic solution and held between SUS plates (Φ15.5 mm). Here, 1 mol/L LiBF₄ propylene carbonate/ethylene carbonate (in a weight ratio of 1/1) was used as the electrolytic solution. The resulting product was enclosed in a 2032-type coin cell. Lead wires were connected to the coin cell, a thermocouple was attached thereto, and the coin cell was placed in an oven. The temperature of the oven was increased at a temperature increase rate of 1.6° C./min, and at the same time, the resistance of the cell was measured by applying an alternating current with an amplitude of 10 mV and a frequency of 1 kHz. In the above-described measurement, if the resistance value within a temperature range of 135 to 150° C. was 10³ ohm·cm² or greater, the SD characteristics were determined as being good (Good), and if not, the SD characteristics were determined as being poor (Poor).

### (n) Rupture Test

A separator sample was fixed to a metal frame that was 6.5 cm in length and 4.5 cm in width. The sample fixed to the metal frame was placed in an oven whose temperature was set at 175° C., and retained for 1 hour. At this time, if the sample was able to maintain its shape without rupturing or the like of the film, the sample was evaluated as “Good”, otherwise the sample was evaluated as “Poor”.

### (o) Presence or Absence of Heat Generation Suppressing Function

The presence or absence of the heat generation suppressing function was analyzed through TADSC (differential scanning calorimetry) using a DSC measurement apparatus (DSC2920 manufactured by TA Instruments Japan Inc.). Measurement samples were prepared by weighing out a piece weighing 5.5 mg from a separator prepared in each of the examples and comparative examples, placing the separator piece into an aluminum pan, and crimping the pan. The measurement was performed in a nitrogen gas atmosphere with a temperature increase rate of 5° C./min within a temperature range of 30 to 500° C. If a significant endothermic peak was observed at 200° C. or more, the sample was determined as having the heat generation suppressing function (Present), otherwise the sample was determined as not having the heat generation suppressing function (Absent).

### (p) Amount of Gas Generated

A separator sample with a size of 110 cm² was cut out and vacuum-dried at 85° C. for 16 hours. The sample was placed in an aluminum pack in an environment at the dew point −60° C. or below, an electrolytic solution was further injected therein, and the aluminum pack was sealed using a vacuum sealer, to prepare a measurement cell. Here, 1 mol/L LiPF₆ ethylene carbonate (EC)/ethyl methyl carbonate (EMC)=3/7 (weight ratio) was used as the electrolytic solution. The measurement cell was stored at 85° C. for 3 days, and the measurement cell before and after storage was measured. A value obtained by subtracting the volume of the measurement cell before storage from the volume of the measurement cell after storage was used as the amount of gas generated. Here, the volume of the measurement cell was measured at 23° C. with the use of an electronic densimeter (EW-300SG manufactured by Alfa Mirage Co., Ltd.), according to the Archimedes' principle.

### (q) Battery Durability

With respect to a nonaqueous secondary battery sample, a constant current/constant voltage charge of 0.2 C and 4.2 V for 8 hours and a constant current discharge of 0.2 C and a cutoff voltage of 2.75 V were performed. The discharge capacity obtained in the fifth cycle was used as the initial capacity of this cell. After that, a constant current/constant voltage charge of 0.2 C and 4.2 V for 8 hours was performed, and the cell was stored at 85° C. for 3 days. Then, a constant current discharge of 0.2 C and a cutoff voltage of 2.75 V was performed to obtain the residual capacity after storage at 85° C. for 3 days. A value obtained by dividing the residual capacity by the initial capacity and multiplying the quotient by 100 was used as the capacity retention rate (%), and this capacity retention rate was used as an index of the battery durability.

### Example 1

### (Preparation of Magnesium Hydroxide A)

Magnesium chloride hexahydrate (first grade reagent manufactured by Wako Pure Chemical Industries, Ltd.) was dissolved in deionized water to prepare an aqueous solution of magnesium chloride with Mg=1.5 mol/L. Sodium hydroxide (first grade reagent manufactured by Wako Pure Chemical Industries, Ltd.) was dissolved in deionized water to prepare an aqueous solution of sodium hydroxide with Na=2.4 mol/L.

The aqueous solution of magnesium chloride and the aqueous solution of sodium hydroxide were continuously supplied into a reaction vessel at 120 mL/min using a metering pump to carry out a coprecipitation reaction. The reaction vessel was made of stainless steel and had a capacity of 240 mL and an overflow structure, and 100 mL of deionized water was placed in this reaction vessel in advance, the temperature of the deionized water was adjusted to 30° C., and the deionized water was stirred at 500 rpm using a stirrer. The raw materials, whose temperature was adjusted to 30° C. as well, were supplied into the reaction vessel, with the flow rates being adjusted such that the reaction pH was 9.6.

The obtained suspension containing magnesium hydroxide was suction filtered and washed with an amount of deionized water that was 20 times the mass of magnesium hydroxide in terms of solid content. Deionized water was added to the cake after being washed with water so as to adjust the concentration of magnesium hydroxide to 30 g/L, and stirring was performed using a homomixer to obtain a suspension.

The temperature of the suspension after washing was adjusted to 80° C., and aging of the suspension was performed for 4 hours under stirring at 300 rpm.

An amount of octylic acid (Wako first grade, manufactured by Wako Pure Chemical Industries, Ltd.) that was 2 wt % with respect to the magnesium hydroxide in terms of solid content was weighed out. To this octylic acid, sodium hydroxide (first grade reagent manufactured by Wako Pure Chemical Industries, Ltd.) was added in an amount of 1 eq., followed by heating to 80° C. and stirring, to obtain an octylic acid treatment liquid. The temperature of the suspension after aging was increased to 80° C. as well. The octylic acid treatment liquid was added to the suspension, followed by stirring and retaining at 80° C. for 20 minutes, to perform surface treatment. The surface-treated suspension was cooled to 30° C., and then suction filtered and washed with deionized water. The cake after washing was placed in a hot air dryer, dried at 110° C. for 12 hours, and then ground. Thus, a magnesium hydroxide A for a nonaqueous secondary battery separator of the present invention was obtained. Table 1 shows experimental conditions with respect to the magnesium hydroxide A, and Table 2 shows the average width of primary particles, the average width of secondary particles, the degree of monodispersity, D90/D10, the crystal strain in the <101> direction, the aspect ratio of primary particles, and the amount of impurities. FIG. 3 shows a SEM micrograph at a magnification of 20,000 of the magnesium hydroxide A.

### (Preparation of Polyethylene Microporous Membrane)

GUR2126 (weight average molecular weight: 4,150,000, melting point: 141° C.) and GURX143 (weight average molecular weight: 560,000, melting point: 135° C.) manufactured by Ticona were used as a polyethylene powder. GUR2126 and GURX143 in a ratio (weight ratio) of 1:9 were dissolved in a mixed solvent of liquid paraffin (SMOIL P-350P manufactured by Matsumura Oil Co., Ltd., boiling point: 480° C.) and decalin such that the polyethylene concentration was 30 wt %, to prepare a polyethylene solution. The composition of the polyethylene solution was adjusted to be polyethylene:liquid paraffin:decalin=30:45:25 (weight ratio).

This polyethylene solution was extruded at 148° C. from a die and cooled in a water bath to prepare a piece of gel-like tape (base tape). The base tape was dried at 60° C. for 8 minutes and at 95° C. for 15 minutes, and the resulting base tape was biaxially stretched by performing longitudinal stretching and transverse stretching in sequence. Here, the longitudinal stretching was performed to a stretching factor of 5.5 at a stretching temperature of 90° C., and the transverse stretching was performed to a stretching factor of 11.0 at a stretching temperature of 105° C. After the base tape was stretched, thermal immobilization was performed at 125° C. Then, the base tape was immersed in a methylene chloride bath to extract the liquid paraffin and the decalin. This was followed by drying at 50° C. and annealing treatment at 120° C., and thus, a polyethylene microporous membrane was obtained. The obtained polyethylene microporous membrane had a basis weight of 4.5 g/m², a film thickness of 8 μm, a porosity of 46%, a Gurley value of 152 sec/100 cc, and a puncture strength of 310 g.

### (Preparation of Heat-Resistant Porous Layer)

Polyphenylene isophthalamide (Teijinconex manufactured by Teijin Techno Products Limited) was used as a meta-type wholly aromatic polyamide. The Teijinconex was dissolved in dimethylacetamide (DMAc):tripropylene glycol (TPG)=60:40 (weight ratio) to an amount of 6 wt %, to prepare a Teijinconex solution. Subsequently, the above-described magnesium hydroxide A was used and dispersed in the Teijinconex solution so that magnesium hydroxide:Teijinconex=50:50 (weight ratio), to prepare a dispersion.

Two Meyer bars were arranged opposing each other, and an appropriate amount of the dispersion was placed therebetween. The polyethylene microporous membrane was made to pass between the Meyer bars where the dispersion was placed to coat both surfaces of the polyethylene microporous membrane with the dispersion. Here, the clearance between the Meyer bars was set to be 30 μm, and with respect to the rod size of the Meyer bars, #6 was used for both. The coated polyethylene microporous membrane was immersed in a coagulation liquid at 30° C., the coagulation liquid having a composition of water:DMAc:TPG=70:18:12 (weight ratio) in terms of weight ratio, then washed with water and dried to prepare heat-resistant porous layers on both the front and back surfaces of the polyethylene microporous membrane, the heat-resistant porous layers containing the magnesium hydroxide and Teijinconex. Thus, a nonaqueous secondary battery separator of the present invention was obtained. Table 3 shows the characteristics of the obtained nonaqueous secondary battery separator.

### (Preparation of Nonaqueous Secondary Battery)

A lithium cobalt oxide (LiCoO₂ manufactured by Nippon Chemical Industrial Co., Ltd.) powder in an amount of 89.5 wt %, acetylene black (DENKA BLACK manufactured by Denka Company Limited) in an amount of 4.5 wt %, and polyvinylidene fluoride (manufactured by Kureha Corporation) in an amount of 6 wt % were kneaded using an N-methyl-2-pyrrolidone solvent to prepare a suspension. The obtained suspension was applied onto an aluminum foil with a thickness of 20 μm, dried, and then pressed to obtain a positive electrode with a thickness of 100 μm.

A mesophase carbon microbeads (MCMB manufactured by Osaka Gas Chemicals Co., Ltd.) powder in an amount of 87 wt %, acetylene black (DENKA BLACK manufactured by Denka Company Limited) in an amount of 3 wt %, and polyvinylidene fluoride (manufactured by Kureha Corporation) in an amount of 10 wt % were kneaded using an N-methyl-2-pyrrolidone solvent to prepare a suspension. The obtained suspension was applied onto a copper foil with a thickness of 18 μm, dried, and then pressed to obtain a negative electrode with a thickness of 90 μm.

The above-described positive and negative electrodes were arranged opposing each other via the above-described separator. This arrangement was impregnated with an electrolytic solution and enclosed in an exterior material including an aluminum laminate film, to obtain a nonaqueous secondary battery of the present invention. Here, 1 mol/L LiPF₆ ethylene carbonate/ethyl methyl carbonate (in a weight ratio of 3/7) was used as the electrolytic solution. Table 3 shows the durability of the obtained nonaqueous secondary battery.

### Example 2

### (Preparation of Magnesium Hydroxide B)

Magnesium chloride hexahydrate (first grade reagent manufactured by Wako Pure Chemical Industries, Ltd.) was dissolved in deionized water to prepare an aqueous solution of magnesium chloride with Mg=1.5 mol/L. Sodium hydroxide (first grade reagent manufactured by Wako Pure Chemical Industries, Ltd.) was dissolved in deionized water to prepare an aqueous solution of sodium hydroxide with Na=2.4 mol/L.

The aqueous solution of magnesium chloride and the aqueous solution of sodium hydroxide were continuously supplied into a reaction vessel at 120 mL/min using a metering pump to carry out a coprecipitation reaction. The reaction vessel was made of stainless steel and had a capacity of 240 mL and an overflow structure, and 100 mL of deionized water was placed in this reaction vessel in advance, the temperature of the deionized water was adjusted to 30° C., and the deionized water was stirred at 500 rpm using a stirrer. The raw materials, whose temperature was adjusted to 30° C. as well, were supplied into the reaction vessel, with the flow rates being adjusted such that the reaction pH was 9.6.

The obtained suspension containing magnesium hydroxide was suction filtered and washed with an amount of deionized water that was 20 times the mass of magnesium hydroxide in terms of solid content. Deionized water was added to the cake after being washed with water so as to adjust the concentration of magnesium hydroxide to 30 g/L, and then stirring was performed using a homomixer to obtain a suspension.

The suspension after washing was placed in an autoclave and subjected to hydrothermal treatment at 120° C. for 4 hours under stirring at 300 rpm.

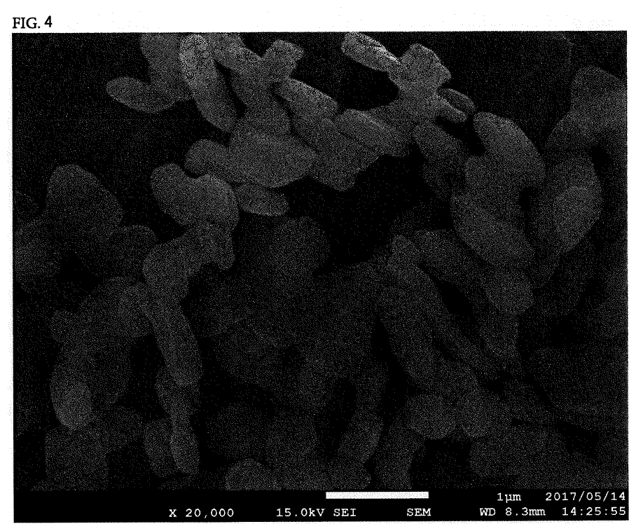

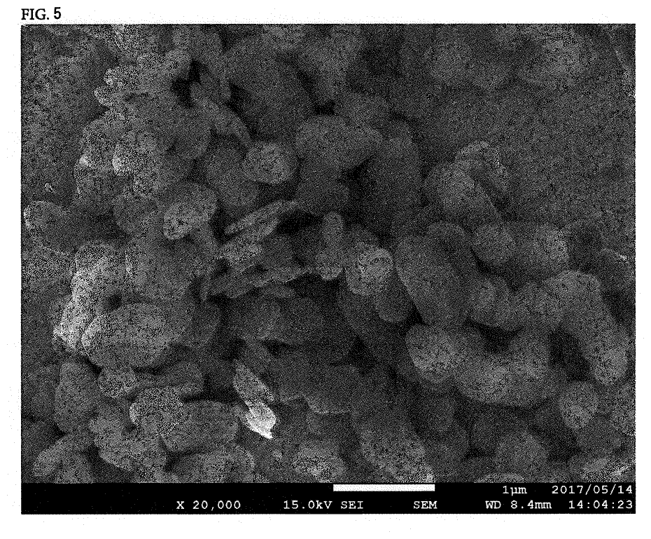

An amount of octylic acid (Wako first grade, manufactured by Wako Pure Chemical Industries, Ltd.) that was 2 wt % with respect to the magnesium hydroxide in terms of solid content was weighed out. To this octylic acid, sodium hydroxide (first grade reagent manufactured by Wako Pure Chemical Industries, Ltd.) was added in an amount of 1 eq., followed by heating to 80° C. and stirring, to obtain an octylic acid treatment liquid. The temperature of the suspension after the hydrothermal treatment was increased to 80° C. as well. The octylic acid treatment liquid was added to the suspension, followed by stirring and retaining at 80° C. for 20 minutes, to perform surface treatment. The surface-treated suspension was cooled to 30° C., and then suction filtered and washed with deionized water. The cake after washing was placed in a hot air dryer, dried at 110° C. for 12 hours, and then ground. Thus, a magnesium hydroxide B for a nonaqueous secondary battery separator of the present invention was obtained. Table 1 shows experimental conditions with respect to the magnesium hydroxide B, and Table 2 shows the average width of primary particles, the average width of secondary particles, the degree of monodispersity, D90/D10, the crystal strain in the <101> direction, the aspect ratio of primary particles, and the amount of impurities. FIG. 4 shows a SEM micrograph at a magnification of 20,000 of the magnesium hydroxide B.

A sample was prepared in a similar manner to Example 1, except that the magnesium hydroxide B was used instead of the magnesium hydroxide A, and thus, a nonaqueous secondary battery separator was obtained. Table 3 shows the characteristics of the obtained nonaqueous secondary battery separator.

A nonaqueous secondary battery was prepared in a similar manner to Example 1, and thus, a nonaqueous secondary battery of the present invention was obtained. Table 3 shows the durability of the obtained nonaqueous secondary battery.

### Example 3

### (Preparation of Magnesium Hydroxide C)

Magnesium chloride hexahydrate (first grade reagent manufactured by Wako Pure Chemical Industries, Ltd.) and sodium acetate (special grade reagent manufactured by Wako Pure Chemical Industries, Ltd.) were dissolved in deionized water to prepare a mixed aqueous solution of magnesium chloride+sodium acetate with Mg=1.5 mol/L and Na=0.375 mol/L. Sodium hydroxide (first grade reagent manufactured by Wako Pure Chemical Industries, Ltd.) was dissolved in deionized water to prepare an aqueous solution of sodium hydroxide with Na=2.4 mol/L.

The aqueous solution of magnesium chloride+sodium acetate and the aqueous solution of sodium hydroxide were continuously supplied into a reaction vessel at 120 mL/min using a metering pump to carry out a coprecipitation reaction. The reaction vessel was made of stainless steel and had a capacity of 240 mL and an overflow structure, and 100 mL of deionized water was placed in this reaction vessel in advance, the temperature of the deionized water was adjusted to 30° C., and the deionized water was stirred at 500 rpm using a stirrer. The raw materials, whose temperature was adjusted to 30° C. as well, were supplied into the reaction vessel, with the flow rates being adjusted such that the reaction pH was 9.6.

The obtained suspension containing magnesium hydroxide was suction filtered and washed with an amount of deionized water that was 20 times the mass of magnesium hydroxide in terms of solid content. Deionized water was added to the cake after being washed with water so as to adjust the concentration of magnesium hydroxide to 30 g/L, and then stirring was performed using a homomixer to obtain a suspension.

The temperature of the suspension after washing was adjusted to 120° C., and aging of the suspension was performed for 4 hours under stirring at 300 rpm.

An amount of octylic acid (Wako first grade, manufactured by Wako Pure Chemical Industries, Ltd.) that was 2 wt % with respect to the magnesium hydroxide in terms of solid content was weighed out. To this octylic acid, sodium hydroxide (first grade reagent manufactured by Wako Pure Chemical Industries, Ltd.) was added in an amount of 1 eq., followed by heating to 80° C. and stirring, to obtain an octylic acid treatment liquid. The temperature of the suspension after aging was increased to 80° C. as well. The octylic acid treatment liquid was added to the suspension, followed by stirring and retaining at 80° C. for 20 minutes, to perform surface treatment. The surface-treated suspension was cooled to 30° C., and then suction filtered and washed with deionized water. The cake after washing was placed in a hot air dryer, dried at 110° C. for 12 hours, and then ground. Thus, a magnesium hydroxide C for a nonaqueous secondary battery separator of the present invention was obtained. Table 1 shows experimental conditions with respect to the magnesium hydroxide C, and Table 2 shows the average width of primary particles, the average width of secondary particles, the degree of monodispersity, D90/D10, the crystal strain in the <101> direction, the aspect ratio of primary particles, and the amount of impurities. FIG. 5 shows a SEM micrograph at a magnification of 20,000 of the magnesium hydroxide C.

A sample was prepared in a similar manner to Example 1, except that the magnesium hydroxide C was used instead of the magnesium hydroxide A, and thus, a nonaqueous secondary battery separator was obtained. Table 3 shows the characteristics of the obtained nonaqueous secondary battery separator.

A nonaqueous secondary battery was prepared in a similar manner to Example 1, and thus, a nonaqueous secondary battery of the present invention was obtained. Table 3 shows the durability of the obtained nonaqueous secondary battery.

### Comparative Example 1

### (Preparation of Magnesium Hydroxide D)

Magnesium chloride hexahydrate (first grade reagent manufactured by Wako Pure Chemical Industries, Ltd.) was dissolved in deionized water to prepare an aqueous solution of magnesium chloride with Mg=1.5 mol/L. Sodium hydroxide (first grade reagent manufactured by Wako Pure Chemical Industries, Ltd.) was dissolved in deionized water to prepare an aqueous solution of sodium hydroxide with Na=2.4 mol/L.

The aqueous solution of magnesium chloride and the aqueous solution of sodium hydroxide were continuously supplied into a reaction vessel at 120 mL/min using a metering pump to carry out a coprecipitation reaction. The reaction vessel was made of stainless steel and had a capacity of 240 mL and an overflow structure, and 100 mL of deionized water was placed in this reaction vessel in advance, the temperature of the deionized water was adjusted to 30° C., and the deionized water was stirred at 500 rpm using a stirrer. The raw materials, whose temperature was adjusted to 30° C. as well, were supplied into the reaction vessel, with the flow rates being adjusted such that the reaction pH was 9.6.

The obtained suspension containing magnesium hydroxide was suction filtered and washed with an amount of deionized water that was 20 times the mass of magnesium hydroxide in terms of solid content. Deionized water was added to the cake after being washed with water so as to adjust the concentration of magnesium hydroxide to 30 g/L, and then stirring was performed using a homomixer to obtain a suspension.

The suspension after washing was placed in an autoclave and subjected to hydrothermal treatment at 170° C. for 4 hours under stirring at 300 rpm.

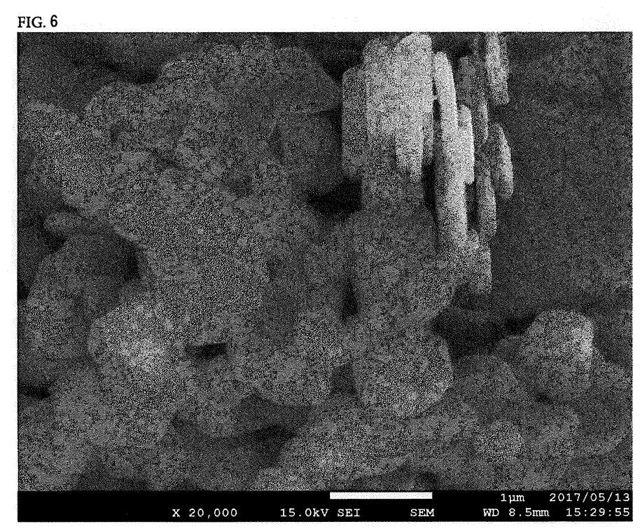

An amount of octylic acid (Wako first grade, manufactured by Wako Pure Chemical Industries, Ltd.) that was 2 wt % with respect to the magnesium hydroxide in terms of solid content was weighed out. To this octylic acid, sodium hydroxide (first grade reagent manufactured by Wako Pure Chemical Industries, Ltd.) was added in an amount of 1 eq., followed by heating to 80° C. and stirring, to obtain an octylic acid treatment liquid. The temperature of the suspension after the hydrothermal treatment was increased to 80° C. as well. The octylic acid treatment liquid was added to the suspension, followed by stirring and retaining at 80° C. for 20 minutes, to perform surface treatment. The surface-treated suspension was cooled to 30° C., and then suction filtered and washed with deionized water. The cake after washing was placed in a hot air dryer, dried at 110° C. for 12 hours, and then ground. Thus, a magnesium hydroxide D was obtained. Table 1 shows experimental conditions with respect to the magnesium hydroxide D, and Table 2 shows the average width of primary particles, the average width of secondary particles, the degree of monodispersity, D90/D10, the crystal strain in the <101> direction, the aspect ratio of primary particles, and the amount of impurities. FIG. 6 shows a SEM micrograph at a magnification of 20,000 of the magnesium hydroxide D.

A sample was prepared in a similar manner to Example 1, except that the magnesium hydroxide D was used instead of the magnesium hydroxide A, and thus, a nonaqueous secondary battery separator was obtained. Table 3 shows the characteristics of the obtained nonaqueous secondary battery separator.

A nonaqueous secondary battery was prepared in a similar manner to Example 1. Table 3 shows the durability of the obtained nonaqueous secondary battery.

### Comparative Example 2

### (Preparation of Magnesium Hydroxide E)

Magnesium chloride hexahydrate (first grade reagent manufactured by Wako Pure Chemical Industries, Ltd.) was dissolved in deionized water to prepare an aqueous solution of magnesium chloride with Mg=1.5 mol/L. Sodium hydroxide (first grade reagent manufactured by Wako Pure Chemical Industries, Ltd.) was dissolved in deionized water to prepare an aqueous solution of sodium hydroxide with Na=2.4 mol/L.

One liter of the aqueous solution of magnesium chloride was placed in a reaction vessel, and the temperature thereof was adjusted to 30° C. under stirring at 500 rpm. Then, 1.6 L of the aqueous solution of sodium hydroxide whose temperature was adjusted to 30° C. as well was supplied into the reaction vessel at 120 mL/min using a metering pump to carry out a reaction. The suspension after the reaction had a pH of 9.6.

The obtained suspension containing magnesium hydroxide was suction filtered and washed with an amount of deionized water that was 20 times the mass of magnesium hydroxide in terms of solid content. Deionized water was added to the cake after being washed with water so as to adjust the concentration of magnesium hydroxide to 30 g/L, and then stirring was performed using a homomixer to obtain a suspension.

The suspension after washing was placed in an autoclave and subjected to hydrothermal treatment at 80° C. for 4 hours under stirring at 300 rpm.

An amount of octylic acid (Wako first grade, manufactured by Wako Pure Chemical Industries, Ltd.) that was 2 wt % with respect to the magnesium hydroxide in terms of solid content was weighed out. To this octylic acid, sodium hydroxide (first grade reagent manufactured by Wako Pure Chemical Industries, Ltd.) was added in an amount of 1 eq., followed by heating to 80° C. under stirring, to obtain an octylic acid treatment liquid. The temperature of the suspension after the hydrothermal treatment was increased to 80° C. as well. The octylic acid treatment liquid was added to the suspension, followed by stirring and retaining at 80° C. for 20 minutes, to perform surface treatment. The surface-treated suspension was cooled to 30° C., and then suction filtered and washed with deionized water. The cake after washing was placed in a hot air dryer, dried at 110° C. for 12 hours, and then ground. Thus, a magnesium hydroxide E was obtained. Table 1 shows experimental conditions with respect to the magnesium hydroxide E, and Table 2 shows the average width of primary particles, the average width of secondary particles, the degree of monodispersity, D90/D10, the crystal strain in the <101> direction, the aspect ratio of primary particles, and the amount of impurities.

A sample was prepared in a similar manner to Example 1, except that the magnesium hydroxide E was used instead of the magnesium hydroxide A, and thus, a nonaqueous secondary battery separator was obtained. Table 3 shows the characteristics of the obtained nonaqueous secondary battery separator.

A nonaqueous secondary battery was prepared in a similar manner to Example 1. Table 3 shows the durability of the obtained nonaqueous secondary battery.

### Comparative Example 3

### (Preparation of Magnesium Hydroxide F)

Magnesium chloride hexahydrate (first grade reagent manufactured by Wako Pure Chemical Industries, Ltd.) was dissolved in deionized water to prepare an aqueous solution of magnesium chloride with Mg=1.5 mol/L. Sodium hydroxide (first grade reagent manufactured by Wako Pure Chemical Industries, Ltd.) was dissolved in deionized water to prepare an aqueous solution of sodium hydroxide with Na=2.4 mol/L.

The aqueous solution of magnesium chloride and the aqueous solution of sodium hydroxide were continuously supplied into a reaction vessel at 120 mL/min using a metering pump to carry out a coprecipitation reaction. The reaction vessel was made of stainless steel and had a capacity of 240 mL and an overflow structure, and 100 mL of deionized water was placed in this reaction vessel in advance, the temperature of the deionized water was adjusted to 30° C., and the deionized water was stirred at 500 rpm using a stirrer. The raw materials, whose temperature was adjusted to 30° C. as well, were supplied into the reaction vessel, with the flow rates being adjusted such that the reaction pH was 9.6.

The obtained suspension containing magnesium hydroxide was suction filtered and washed with an amount of deionized water that was 20 times the mass of magnesium hydroxide in terms of solid content. Deionized water was added to the cake after being washed with water so as to adjust the concentration of magnesium hydroxide to 30 g/L, and then stirring was performed using a homomixer to obtain a suspension.

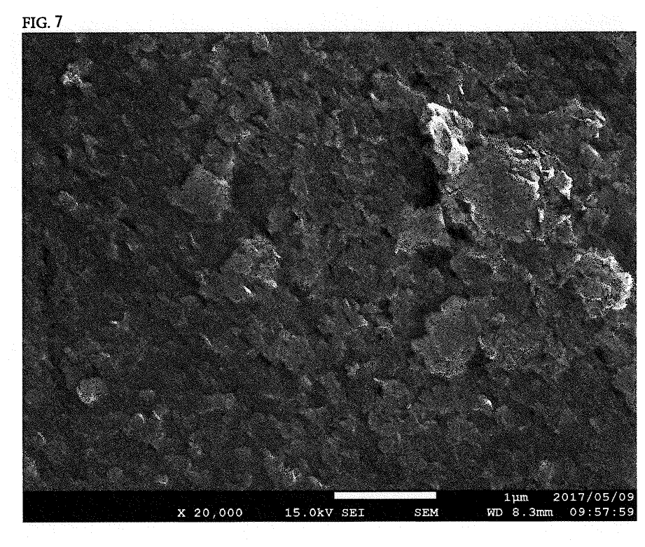

An amount of octylic acid (Wako first grade, manufactured by Wako Pure Chemical Industries, Ltd.) that was 2 wt % with respect to the magnesium hydroxide in terms of solid content was weighed out. To this octylic acid, sodium hydroxide (first grade reagent manufactured by Wako Pure Chemical Industries, Ltd.) was added in an amount of 1 eq., followed by heating to 80° C. and stirring, to obtain an octylic acid treatment liquid. The temperature of the suspension after aging was increased to 80° C. as well. The octylic acid treatment liquid was added to the suspension, followed by stirring and retaining at 80° C. for 20 minutes, to perform surface treatment. The surface-treated suspension was cooled to 30° C., and then suction filtered and washed with deionized water. The cake after washing was placed in a hot air dryer, dried at 110° C. for 12 hours, and then ground. Thus, a magnesium hydroxide F was obtained. Table 1 shows experimental conditions with respect to the magnesium hydroxide F, and Table 2 shows the average width of primary particles, the average width of secondary particles, the degree of monodispersity, D90/D10, the crystal strain in the <101> direction, the aspect ratio of primary particles, and the amount of impurities. FIG. 7 shows a SEM micrograph at a magnification of 20,000 of the magnesium hydroxide F.

A sample was prepared in a similar manner to Example 1, except that the magnesium hydroxide F was used instead of the magnesium hydroxide A, and thus, a nonaqueous secondary battery separator was obtained. Table 3 shows the characteristics of the obtained nonaqueous secondary battery separator.

A nonaqueous secondary battery was prepared in a similar manner to Example 1. Table 3 shows the durability of the obtained nonaqueous secondary battery.

TABLE 1

| | | Ex. 1 | Ex. 2 | Ex. 3 |
|---|---|---|---|---|
| Raw material 1 | Substance name | Magnesium | ← | ← |
| | | chloride | | |
| | Concentration | 1.5 | ← | ← |
| | (mol/L) | | | |
| Raw material 2 | Substance name | Sodium | ← | ← |
| | | hydroxide | | |
| | Concentration | 2.4 | ← | ← |
| | (mol/L) | | | |
| Raw material 3 | Substance name | | | Sodium |
| | | | | acetate |
| | Concentration | | | 0.375 |
| | (mol/L) | | | |
| Reaction | Reaction method | Continuous | ← | ← |
| | pH | 9.6 | ← | ← |
| Aging | Retaining | 80 | 120 | ← |
| | temperature | | | |
| | (° C.) | | | |
| | Retaining time | 4 | ← | ← |
| | (h) | | | |
| Surface | Treatment agent | Octylic acid | ← | ← |
| treatment | Treatment amount | 2 | ← | ← |
| | (wt %) | | | |

| | | Com. Ex. 1 | Com. Ex. 2 | Com. Ex. 3 |
|---|---|---|---|---|
| Raw material 1 | Substance name | Magnesium | ← | ← |
| | | chloride | | |
| | Concentration | 1.5 | ← | ← |
| | (mol/L) | | | |
| Raw material 2 | Substance name | Sodium | ← | ← |
| | | hydroxide | | |
| | Concentration | 2.4 | ← | ← |
| | (mol/L) | | | |
| | Substance name | | | |
| Raw material 3 | Concentration | | | |
| | (mol/L) | | | |
| Reaction | Reaction method | Continuous | Batch | Continuous |
| | pH | 9.6 | ← | ← |
| Aging | Retaining | 170 | 80 | |
| | temperature | | | |
| | (° C.) | | | |
| | Retaining time | 4 | ← | |
| | (h) | | | |
| Surface | Treatment agent | Octylic acid | ← | ← |
| treatment | Treatment amount | 2 | ← | ← |
| | (wt %) | | | |

TABLE 2

| | | Ex. 1 | Ex. 2 | Ex. 3 |
|---|---|---|---|---|
| | | Sample No. | | |
| | | A | B | C |
| Primary particles | Average width | 0.21 | 0.46 | 0.53 |
| | (μm) | | | |
| | Average | 56 | 78 | 35 |
| | thickness | | | |
| | (nm) | | | |
| | Aspect ratio | 4 | 6 | 15 |
| Secondary particles | Average width | 0.26 | 0.52 | 0.64 |
| | (μm) | | | |
| | D90 (μm) | 0.31 | 0.57 | 0.89 |
| | D10 (μm) | 0.22 | 0.45 | 0.57 |
| | D90/D10 | 1.41 | 1.27 | 1.56 |
| Degree of | (%) | 81 | 88 | 83 |
| monodispersity | | | | |
| Zeta potential | (mV) | 36 | 34 | 33 |
| Crystal strain in the <101> | | 1.8 × 10⁻³ | 1.3 × 10⁻³ | 2.4 × 10⁻³ |
| direction | | | | |
| Amount of impurities | (ppm) | 8 | 7 | 8 |
| (Cr + Mn + Fe + Co + | | | | |
| Ni + Cu + Zn) | | | | |
| Surface treatment | Type | Octylic | ← | ← |
| | | acid | | |
| | Treatment amount | 1.8 | 1.9 | 1.8 |
| | (wt %) | | | |

| | | Com. Ex. 1 | Com. Ex. 2 | Com. Ex. 3 |
|---|---|---|---|---|
| | | Sample No. | | |
| | | D | E | F |
| Primary particles | Average width | 0.78 | 0.24 | 0.12 |
| | (μm) | | | |
| | Average thickness | 212 | 61 | 45 |
| | (nm) | | | |
| | Aspect ratio | 4 | 4 | 3 |
| Secondary particles | Average width | 0.91 | 0.54 | 10.53 |
| | (μm) | | | |
| | D90 (μm) | 1.12 | 3.43 | 20.53 |
| | D10 (μm) | 0.86 | 0.28 | 1.21 |
| | D90/D10 | 1.30 | 12.25 | 16.97 |
| Degree of | (%) | 86 | 44 | 1 |
| monodispersity | | | | |
| Zeta potential | (mV) | 34 | 12 | 2 |
| Crystal strain in the <101> | | 1.2 × 10⁻³ | 6.4 × 10⁻³ | 3.2 × 10⁻² |
| direction | | | | |
| Amount of impurities | (ppm) | 8 | 9 | ← |
| (Cr + Mn + Fe + Co + | | | | |
| Ni + Cu + Zn) | | | | |
| Surface treatment | Type | Octylic | ← | ← |
| | | acid | | |
| | Treatment | 1.7 | 1.8 | ← |
| | amount | | | |
| | (wt %) | | | |

Tables 1 and 2 show that the magnesium hydroxides of the present invention had an average width of primary particles within a range of 0.1 to 0.7 μm, an absolute value of zeta potential of 15 mV or greater, and a degree of monodispersity of 50% or greater. Moreover, the magnesium hydroxides of the present invention had a crystal strain in the <101> direction of 3×10⁻³ or less, and therefore, it can be seen that these magnesium hydroxides had fewer crystal lattice defects. Furthermore, it can be seen that the magnesium hydroxide C of Example 3 had an increased aspect ratio of primary particles due to the effect of adding sodium acetate.

The magnesium hydroxide D of Comparative Example 1 had an average width of primary particles of greater than 0.7 μm. The magnesium hydroxide E of Comparative Example 2 and the magnesium hydroxide F of Comparative Example 3 had a crystal strain in the <101> direction of greater than 3×10⁻³, and primary particles thereof were aggregated. Therefore, these magnesium hydroxides had a low degree of monodispersity and a low absolute value of zeta potential.

TABLE 3

| | | | | | Com. | Com. | Com. |
|---|---|---|---|---|---|---|---|
| | | Ex. 1 | Ex. 2 | Ex. 3 | Ex. 1 | Ex. 2 | Ex. 3 |
| Film thickness of | (μm) | 16 | ← | ← | ← | ← | ← |
| separator | | | | | | | |
| SD characteristics | | Good | Good | Good | Good | Good | Poor |
| Rupture test | | Good | Good | Good | Good | Good | Poor |
| Heat generation | | Present | Present | Present | Present | Present | Absent |
| suppressing function | | | | | | | |
| Amount of gas | (cc) | 0.4 | 0.4 | 0.1 | 1.1 | 1.4 | 3.1 |
| generated | | | | | | | |
| Battery | (%) | 91 | 87 | 93 | 74 | 72 | 43 |
| durability | | | | | | | |

It can be seen from Table 3 that the nonaqueous secondary batteries of the present invention showed favorable results with respect to all of the shutdown characteristics, the rupture test, and the heat generation suppressing function. The amounts of gas generated by the separators of the present invention were small compared with those of the comparative examples. In particular, the amount of gas generated by the separator of Example 3, in which the magnesium hydroxide having the high aspect ratio was used, was significantly small.

### INDUSTRIAL APPLICABILITY

A nonaqueous secondary battery separator in which a magnesium hydroxide of the present invention is used contributes to an improvement in the safety and the durability of a nonaqueous secondary battery and a reduction in the size thereof.

### REFERENCE SIGNS LIST

W₁ Width of primary particle
W₂ Width of secondary particle
T₁ Thickness of primary particle

1. A magnesium hydroxide for use in a nonaqueous secondary battery separator, the magnesium hydroxide satisfying (A) to (D) below:
(A) primary particles having an average width as measured using a SEM method of between 0.1 μm and 0.7 μm inclusive;
(B) a degree of monodispersity of 50% or greater, wherein:
the degree of monodispersity (%)=(average width of primary particles as measured using the SEM method/average width of secondary particles as measured using a laser diffraction method)×100;
(C) a ratio D90/D10 of a volume-based cumulative 90% particle diameter (D90) to a volume-based cumulative 10% particle diameter (D10) as measured using a laser diffraction method of 10 or less; and
(D) a lattice strain in the <101> direction as measured using an X-ray diffraction method is 3×10⁻³ or less.

2. The magnesium hydroxide according to claim 1, wherein an average thickness of primary particles as measured using a SEM method is between 20 nm and 100 nm inclusive.

3. The magnesium hydroxide according to claim 1, wherein the volume-based cumulative 90% particle diameter (D90) as measured using the laser diffraction method is 1 μm or less.

4. The magnesium hydroxide according to claim 1, wherein an absolute value of zeta potential is 15 mV or greater.

5. The magnesium hydroxide according to claim 1, wherein a total amount of a chromium compound, a manganese compound, an iron compound, a cobalt compound, a nickel compound, a copper compound, and a zinc compound that are contained is 200 ppm or less in terms of metals (Cr, Mn, Fe, Co, Ni, Cu, and Zn).

6. The magnesium hydroxide according to claim 1, wherein a crystal surface thereof is surface-treated with at least one selected from the group consisting of an anionic surfactant, a cationic surfactant, a phosphate ester treatment agent, a silane coupling agent, a titanate coupling agent, an aluminum coupling agent, a silicone-based treatment agent, silicic acid, and water glass.

7. A nonaqueous secondary battery separator comprising:
a polyolefin porous base material; and
a heat-resistant porous layer laminated on one or both surfaces of the porous base material,
wherein the heat-resistant porous layer contains a heat-resistant resin and the magnesium hydroxide according to claim 1.

8. A nonaqueous secondary battery configured to obtain an electromotive force through doping and de-doping of lithium, wherein the nonaqueous secondary battery includes the nonaqueous secondary battery separator according to claim 7.
